(19) United States
(12) Patent Application Publication
(10) Pub. No.: US 2009/0191356 A1
(43) Pub. Date: Jul. 30, 2009

(54) Method for forming a thin layer of particulate on a substrate

(76) Inventors: Hee Hyun Lee, Wilmington, DE (US); Graciela Beatriz Blanchet, Wilmington, DE (US); James F. Ryley, Glen Mills, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/217,164

(22) Filed: Jul. 2, 2008

Related U.S. Application Data
(63) Continuation-in-part of application No. 12/011,558, filed on Jan. 28, 2008.

(51) Int. Cl. H05H 1/00

(52) U.S. Cl. 427/535

(57) ABSTRACT

The invention is a method for forming a thin layer of particulate on a substrate by applying a layer of a composition comprising the particulate and a dispersing agent on the substrate, treating the layer with charged gas to remove the dispersing agent from the layer; and induction heating to form operative connection of the particulate.

### BACKGROUND OF THE INVENTION

1. Field of the Disclosure

This invention pertains to a method for forming a layer of particulate on a substrate, and in particular, the method forms a thin layer of nanometer sized particulate on a substrate for use in microfabrication of components and devices.

2. Description of Related Art

Nearly all electronic and optical devices require patterning. Microelectronic devices have been prepared by photolithographic processes to form the necessary patterns. According to this technique a thin film of conducting, insulating or semiconducting material is deposited on a substrate and a negative or positive photoresist is coated onto the exposed surface of the material. The resist is then irradiated in a predetermined pattern, and irradiated or non-irradiated portions of the resist are washed from the surface to produce a predetermined pattern of resist on the surface. To form a pattern of a conducting metal material, the metal material that is not covered by the predetermined resist pattern is then etched or removed. The resist pattern is then removed to obtain the pattern of metal material. Photolithography, however, is a complex, multi-step process that is too costly for the printing of plastic electronics.

Contact printing is a flexible, non-lithographic method for forming patterned materials. Contact printing potentially provides a significant advance over conventional photolithographic techniques since the contact printing can form relatively high resolution patterns on plastic electronics for electronic parts assembly. Microcontact printing can be characterized as a high-resolution technique that enables patterns of micron dimensions to be imparted onto a substrate surface. Microcontact printing is also more economical than photolithography systems since it is procedurally less complex, ultimately not requiring spin coating equipment or a sequential development step. In addition, microcontact printing potentially lends itself to reel-to-reel electronic parts assembly operations that allows for high throughput production than other techniques, such as photolithography and e-beam lithography (which is a conventional technique employed where resolution on the order of 10 s of nanometer is desired). Multiple images can be printed from a single stamp in reel-to-reel assembly operations using microcontact printing.

Contact printing is a possible replacement to photolithography in the fabrication of microelectronic devices, such as radio frequency tags (RFID), sensors, and memory and backpanel displays. The capability of microcontact printing to transfer a self-assembled monolayer (SAM) forming molecular species to a substrate has also found application in patterned electroless deposition of metals. SAM printing is capable of creating high resolution patterns, but is generally limited to forming metal patterns of gold or silver with thiol chemistry. Although there are variations, in SAM printing a positive relief pattern provided on an elastomeric stamp is inked onto a substrate. The relief pattern of the elastomeric stamp, which is typically made of polydimethylsiloxane (PDMS), is inked with a thiol material. Typically the thiol material is an alkane thiol material. The substrate is blanket-coated with a thin metal film of gold or silver, and then the gold-coated substrate is contacted with the stamp. Upon contact of the relief pattern of the stamp with the metal film, a monolayer of the thiol material having the desired microcircuit pattern is transferred to the metal film. Alkane thiols form an ordered monolayer on metal by a self-assembly process, which results in the SAM being tightly packed and well adhered to the metal. As such, the SAM acts as an etch resist when the inked substrate is then immersed in a metal etching solution and all but the SAM-protected metal areas are etched away to the underlying substrate. The SAM is then stripped away leaving the metal in the desired pattern.

Although it has been shown that 20 nm features can be achieved when printing via thiol chemistry, it is limited to a few metals and is not compatible with reel-to-reel processes. In contrast, it is difficult to form patterns of functional material with resolution on the order of 50 micron or less, and particularly 1 to 5 micron, by direct relief printing of the functional material.

Metal nanoparticle inks are currently used to make conductive layers or patterns on substrates in printable electronic devices. After patterning the metal lines on the substrate, the surfactants are removed and the particles sintered in a thermal sintering process to form highly conductive metal patterns. But thermal sintering processes typically occur at or above 200° C. which is not compatible with plastic substrates because plastic substrates can deform from the heat. Deformation or distortion of plastic substrates can destroy the functionality of or compatibility in the electronic device. Yet it is desirable to use polymeric or plastic substrates in low-end and/or inexpensive electronic devices.

Induction heating of patterned substrates has also been used to sinter metal particles. But induction heating is not efficient at removing organic components between the metal particles and can take extended periods of time.

So it is desirable to provide a method to form a layer of particulate on a substrate. It is desirable to form a thin layer of the particulate from conductive metal ink on a substrate, particularly on a plastic substrate. It is desirable to create a conductive path in the thin layer of metal nanoparticles for use in an electronic device. It is also desirable to sinter or at least form a functional path of the metal nanoparticle ink at a temperature low enough to avoid thermal distortion of the plastic substrate.

It is also desirable to provide a method for forming a pattern of a functional material onto a substrate. It is desirable for the method to directly form the pattern of the functional material on the substrate. It is desirable to form the pattern of a conductive material from metal nanoparticle ink on a plastic substrate. It is desirable to sinter or at least form functional pathways the pattern of metal nanoparticle ink to create a conductive pathway for use in an electronic device. It is desirable to form the conductive pathways of the metal nanoparticle ink at a temperature low enough to avoid distortion of the plastic substrate. It is also desirable for such method to have the ease of microcontact printing with an elastomeric stamp and be capable of reproducing resolution of 50 micron or less.

### SUMMARY OF THE INVENTION

This invention provides a method for forming a thin layer of particulate on a substrate comprising applying a layer of a composition comprising the particulate dispersed in a dispersing agent on the substrate; treating the layer with charged gas to remove the dispersing agent from the layer; and induction heating to form operative connection of the particulate.

Another aspect of this invention provides a method to form a functional pattern on a substrate by providing an elastomeric stamp having a relief structure; applying a composition comprising particulate and a dispersing agent to the relief structure; selectively transferring the composition from relief structure to the substrate to form the pattern; treating the composition with charged gas to remove the dispersing agent; and induction heating to form functional connection of the particulate.

### DESCRIPTION OF THE PREFERRED EMBODIMENT(S)

The present invention provides a method to form a layer, particularly a thin layer, of a particulate on a substrate. The present invention also provides a method to form a pattern of particulate on a substrate. The particulate is a functional material for use in devices and components in a variety of applications, including but not limited to, electronic, optical, sensory, and diagnostic applications. The method is applicable to forming a layer or a pattern of a particulate as the functional material on a substrate, particularly a polymeric or plastic substrate. The method is capable of forming a layer in one embodiment and a pattern in another embodiment of the particulate onto a variety of substrates, particularly substrates made of polymeric or plastic materials. The method is capable of forming functional pathways of the particulate on a substrate and without distortion of the substrate.

The method is capable of forming the particulate pattern over large areas with line resolution of less than 50 micron, and thus is particularly capable of forming microcircuitry. In some embodiments, fine line resolution of 1 to 5 micron can be attained by the present method. The method can employ the ease of printing with an elastomeric stamp having a relief structure to transfer the particulate as a pattern. The method provides clean, featureless (open) background area between the lines of functional material, while retaining image fidelity and resolution associated with conventional microcontact printing. The present method enables printing of a variety of particulate materials over relatively large areas with micron resolution. The method also enables printing of sequential overlays without hampering the functionality of one or more underlying layers. The method can be adapted to high-speed production processes particularly for the fabrication of electronic devices and components, such as reel-to-reel processes.

The method forms a layer of particulate on the substrate. The method includes applying a layer of a composition comprising the particulate dispersed in a surfactant or carrier on the substrate. The layer of particulate on the substrate provides an operative function to a component or device. In some embodiments, the layer can be contiguous covering all or only an operative portion of the substrate. In some embodiments, the layer can be a pattern of operative paths on the substrate.

The particulate is a functional material that is applied to a substrate and treated to facilitate an operation in a variety of components and devices. The particulate may also be referred to herein as a functional material. To the extent that a material can be formed into particles that are dispersed or suspended by a dispersing agent (such as surfactant or polymeric binder), applied to a substrate by any suitable means, and treated with charged gas particles to remove the dispersing agent without deterioration of the material's intrinsic functional property/s, the materials used as the particulate are not limited. The particulate can be an active material or an inactive material. Active materials include, but are not limited to, electrically active materials and photoactive materials. As used herein, the terms “electrically active” and “photoactive” refer to a material which exhibits a predetermined activity in response to a stimulus, such as an electromagnetic field, an electrical potential, solar or other energy radiation, or any combination thereof. Inactive materials include, but are not limited to, insulating materials, such as dielectric materials; planarization materials; barrier materials; and confinement materials. In one embodiment, the planarization material is printed on top of a pattern of pixels in color filters to render all pixels the same height. In one embodiment, the barrier material is a printed pattern to form a barrier so that charges in the cathode facilitate charge injection into a light emitting polymer layer in an organic light emitting diode (OLED). In one embodiment, the confinement material is printed as a pattern that restricts the expansion of a subsequently applied liquid to a particular area defined by the pattern of confinement material. The functional materials for the inactive materials are not limited to only those used in the embodiments described above. In some embodiments, the active materials and inactive materials is an inorganic material. In other embodiments, the active materials and inactive materials may be composite of inorganic material and organic material.

The functional material need not be homogeneous or substantially homogeneous, that is composes of the same essential material. In some embodiments, the functional material is homogeneous. In other embodiments, the functional material can be a mixture of homogeneous particles. In other embodiments, the functional material can be multicomponent composite of particles.

The particulate is not limited, and includes, for example, conductive materials, semi-conductive materials, and dielectric materials. Examples of conductive materials for use as a particulate include, but are not limited to, metals, such as silver, gold, copper, and palladium; metal complexes; metal alloys; metal oxides, such as indium-tin oxide; etc. Examples of semiconductive materials include, but are not limited to, silicon, germanium, gallium arsenide, zinc oxide, and zinc selenide.

Typically, printable semiconducting materials and dielectric materials are polymeric, but to the extent that semiconducting and dielectric materials can be formed or made into particles or particulate and dispersed in a surfactant, these materials are encompassed for use in the present invention. A particulate semiconductor material is described by Volkman et al., in “A Novel Transparent Air-Stable Printable n-type Semiconductor Technology Using ZnO Nanoparticles”, IEEE, 2004. To the extent that other materials, such as, but not limited to, photoactive materials can be formed or made into particles for particulate and dispersed in a surfactant, and their intrinsic functional property is not deteriorated by treatment with a charged gas stream these materials are also encompassed for use in the present invention. The term “photoactive” is intended to mean any material that exhibits photoluminescence, electroluminescence, coloration, or photosensitivity. The term is intended to include, among others, dyes, optical whiteners, photoluminescent materials, compounds reactive to actinic radiation, and photoinitiators.

Particulate for use as a functional material in the present method include particles having a size less than 500 nm. In some embodiments, the particulate has an average particle size of less than 500 nm, such that the particulate may contain individual particles that are larger and smaller than 500 nm, provided that the average particle size is less than 500 nm based on a number average. In some embodiments, the particulate is composed of nanoparticles, which are microscopic particles whose size is measured in nanometers (nm). Nanoparticles include particles having at least one dimension less than 500 nm. In some embodiments, the nanoparticles have a diameter of about 1 to 500 nm. In one embodiment, the nanoparticles have a diameter of about 2 to 100 nm. In other embodiments, the particles have a diameter of about 20 to 200 nm. At the small end of the size range, the nanoparticles may be referred to as clusters. The shape of the nanoparticles is not limited and includes nanospheres, nanorods, and nanocups. Nanoparticles made of semiconducting material may also be called quantum dots, if the particles are small enough (typically less than 10 nm) that quantization of electronic energy levels occurs. Semiconducting materials include light-emifting quantum dots. A bulk material generally has constant physical properties regardless of its size, but for nanoparticles this is often not the case. Size dependent properties are observed such as, quantum confinement in semiconductor particles; surface plasmon resonance (SPR) or localized surface plasmon resonance in some metal particles; and superparamagnetism in magnetic materials. The particulate includes but is not limited to semi-solid nanoparticles, such as; nanocrystals; hybrid structures, such as core-shell nanoparticles. The particulate includes nanoparticles of carbon, such as carbon nanotubes, conducting carbon nanotubes, and semiconducting carbon nanotubes. Metal nanoparticles and dispersions of gold, silver and copper are commercially available from Nanotechnologies, and Advanced Nano Products Co., Ltd. (ANP). In some embodiments, the particulate composition can include from 99 to 1 weight % of the particulate (solids content) based on the total weight of the composition.

The particulate is dispersed or suspended in a solution by dispersing agent, such as a surfactant and/or a binder, forming a composition for application to the substrate. The dispersing agent maintains the particulate as a dispersion or suspension so that the particles do not agglomerate. The dispersing agent used for the composition is not limited. In some embodiments, the dispersing agent can be non-ionic surfactants and ionic surfactants, e.g., anionic, cationic, zwitterionic (dual charge) surfactants. Mixtures of surfactants are also suitable. The surfactant can be amphiphilic, meaning that the surfactant contains both hydrophobic groups and hydrophilic groups. In other embodiments, the dispersing agent can be a polymeric binder, or a combination of polymeric binders. Suitable polymeric binders include, but are not limited to, polyvinylpyrrolidones (PVP) having a molecular weight (Mw) of 1000 to 40,000; and polyvinyl alcohols having a molecular weight (Mw) of 1000 to 40,000. Another example of suitable dispersing agents is one or a mixture of two or more dispersing agents of the BYK series commercially offered by BYK Co. of Germany. The dispersing agent can be one or a mixture of surfactants and/or binders. In some embodiments, the particulate composition can include from 1 to 99 weight % of the dispersing agent based on the total weight of the composition. In some other embodiments, the particulate composition can include from 1 to 10 weight % of the dispersing agent based on the total weight of the composition.

The composition can be further diluted with a liquid to a concentration suitable for use with the chosen application method. The liquid, which may be referred to as a diluent, used for the composition is not limited and can include organic compounds and aqueous compounds. In one embodiment, the liquid is an organic compound that is an alcohol-based compound. The liquid may be a solvent to the dispersing agent, or may be a carrier capable of further dispersing or suspending the material in solution sufficient to conduct the steps of the present method. The liquid may include one or more than one compounds as a solvent for the dispersing agent or carrier for the functional material. In one embodiment, the liquid includes one solvent for the particulate composition. In one other embodiment, the liquid solution includes one carrier compound for the functional material. In another embodiment, the liquid includes two solvents, that is, a co-solvent mixture, for the particulate composition. In some embodiments, the particulate composition includes 1 to 80 weight % of the particulate (solids) based on the total weight of the composition, which includes the particulate, the dispersing agent/s, and the liquid diluent.

The composition of the particulate and the dispersing agent, and optionally the liquid, should at least be capable of: in some embodiments, wetting the substrate to form a layer; in some embodiments, wetting the surface of the stamp for pattern wise application on the substrate; and in some embodiments, wetting at least non-masked (open) areas on exterior surface of a substrate having a pattern of masking material thereon.

The substrate is not limited, and can include, plastic, polymeric films, metal, silicon, glass, fabric, paper, and combinations thereof, provided that at least the layer of the particulate composition can be formed thereon. The substrate can be opaque or transparent. The substrate can be rigid or flexible. The substrate may include one or more layers and/or one or more patterns of other materials, before the pattern of the particulate composition is formed on the substrate. A surface of the substrate can include an adhesion-promoting surface, such as a primer layer, or can be treated to promote adhesion of an adhesive layer or the particulate to the substrate. Some embodiments of substrates include, for example, a metallic film on a polymeric, glass, or ceramic substrate, a metallic film on a conductive film or films on a polymeric substrate, metallic film on a semiconducting film on a polymeric substrate. Further examples of suitable substrates include, for example, glass, indium-tin-oxide coated glass, indium-tin-oxide coated polymeric films; polyethylene terephthalate, polyethylene naphthalate, polyimides, silicon, and metal foils. The substrate can include one or more charge injection layers, charge transporting layers, and semiconducting layers on to which the pattern is transferred.

The present method is particularly suited for plastic or polymeric materials that can form self-supporting films that may distort or deform or become dimensionally unstable at temperatures above about 60° C. The method provides the capability to create functional pathway/s of the particulate on polymeric substrates at a temperature lower than the temperature at which the polymeric film distorts or deforms. In some embodiments, the temperature at which a polymeric film distorts or deforms is the glass transition temperature. In some embodiments polymeric films can distort or deform at about 140° C. In other embodiments polymeric films can distort or deform at about 190° C. In other embodiments polymeric films can distort or deform at about 230° C. These polymeric films cannot undergo various process steps at the elevated temperatures necessary to sinter metal-based particulate for conductive paths in electronic devices. The present invention provides a method to sinter the metal-based particulate on a polymeric film substrate at or below the temperature that the film distorts or deforms.

Examples of polymeric materials that can form a self-supporting film suitable as the substrate include, but is not limited to, cellulosic films such as triacetyl cellulose; and thermoplastic materials such as polyolefins, polycarbonates, polyimides, and polyester. In some embodiments, the substrate includes films of polyethylene, such as polyethylene terephthalate and polyethylene napthalate. Typically the substrate has a thickness between 2 to 50 mils (0.0051 to 0.13 cm). Typically the substrate is in the form of a sheet film or can be web, but is not limited to these forms.

The method for applying the particulate composition as a layer is not limited, including for example, injection, pouring, liquid casting, jetting, immersion, spraying, vapor deposition, and coating. Examples of suitable methods of coating include spin coating, dip coating, slot coating, roller coating, and doctor blading. The particulate composition can also be applied as a patterned layer by transfer from a stamp or a printing form to the substrate. The layer of the particulate composition applied by any of the methods should be sufficiently thin that the treating of the layer with charged gas particles removes the dispersing agent from the layer.

The layer of particulate composition has a thickness when applied of less than about 500 nm. In some embodiments, the layer thickness is about 1 to 500 nm. In some embodiments, the layer thickness is about 1 to 200 nm. In some embodiments, the layer thickness is about 50 to 100 nm.

In the present method, application of the particulate composition to the substrate typically occurs at room temperature, that is, at temperatures between 17 to 30° C. (63 to 86° F.), but is not so limited. The present method can occur at an elevated temperature, up to about 100° C., provided that the heat does not detrimentally impact the elastomeric stamp, the particulate composition, and the substrate and their ability to form the pattern on the substrate.

Treating the layer of particulate composition to charged gas particles removes or substantially removes the dispersing agent from the layer to provide a functional path of the particulate on the substrate. Any liquid in the particulate composition can first be driven off by evaporation after application to the substrate (or to the stamp) by drying or can be driven off by low temperature heating (up to about 65° C.) after application to the substrate. But, drying does not remove the dispersing agent from the particulate composition, and the dispersing agent often remains with the particulate such that a functional path of the particulate is not operable.

Treating the layer or pattern of particulate composition on the substrate subjects the composition to a stream of charged gas, which is referred to as plasma treatment or plasma treating. When sufficient energy is added to a gas, the gas becomes ionized and enters a plasma state. The excitation energy supplied to a gas to form the plasma can originate from electrical discharges, direct currents, radio frequencies, microwaves, or other forms of electromagnetic radiation. The energy is coupled into the gas most commonly by the creation of an electrical field between two electrodes. In some embodiments, the plasma can be generated using inductive coupling or microwave energy in a wave cavity.

Power may be applied to generate the plasma. In some embodiments, the power is between about 50 to about 1500 watt, which translates to power density between about 125 to 4000 mW/cm². The power density is the power per unit area of substrate. In some embodiments, the power is between about 100 to about 900 watt. The DC voltage is in a range of approximately 10 to 1000 V, and the power density is in a range of approximately 10 to 5000 mW/cm². The lower limits on voltage and power density may cause the plasma to be difficult to sustain or produce unacceptably low treatment rates. The upper limits on voltage and power density may be too aggressive and cause the treatment to be uncontrollable, irreproducible (important in manufacturing), or have unacceptably low selectivity. In one embodiment, the DC bias voltage may in a range of approximately 100 to 350 V, and the power may be in a range of approximately 100 to 900 watt. The ramp rate of the voltage and power may be quite high because the voltage and power are typically turned on and off similar to a conventional light switch.

Gas suitable for plasma treating includes, but is not limited to, helium, argon, hydrogen, nitrogen, air, nitrous oxide, ammonia, carbon dioxide, oxygen, and combinations thereof. In some embodiments, plasma treating is conducted with oxygen gas. In some embodiments, plasma treating is conducted with argon gas, or a combination of argon and oxygen.

Plasma treating can be conducted in atmospheric conditions, or may take place in a chamber capable of sustaining the plasma at low pressures or vacuum conditions. In the treating step, feed gas(es) flow into the chamber and the pressure is allowed to stabilize. The pressure is in a range of approximately 10 mTorr to 760 Torr. At these pressures, the feed gas(es) may flow at a rate in a range of approximately 10 to 1000 standard cubic centimeters per minute (“sccm”). In another embodiment, the pressure may be in a range of approximately 35 to 500 mTorr, the feed gas(es) may flow at a rate in a range of approximately 10 to 50 sccm. In still a further embodiment, the pressure may be in a range of approximately 10 mTorr to 760 Torr.

During plasma treatment, the layer of particulate composition on the substrate may be directly exposed to the plasma or may be indirectly exposed to the plasma by introducing the plasma upstream. In this downstream plasma orientation, the plasma is generated at a location that is removed from the location of the particulate composition on the substrate. Recombination of the ions and electrons occurs just outside the plasma zone and long-lived metastable radicals arrive at the composition on the substrate that is located further downstream from the recombination zone, and promote the removal of the dispersing agent and formation of a functional layer.

The operating parameters may vary depending on the type of reactor used, size of the chamber, and/or the size of the composition layer on the substrate being treated.

Plasma treating the layer or pattern of particulate composition removes the dispersing agent from the particulate composition and forms an operative or functional pathway of the particulate material. The composition layer on the substrate is plasma treated for a time sufficient to remove the dispersing agent and cause the particulate material to create a functional or operative layer or pathway on the substrate. In some embodiments, the composition layer can be subjected to plasma treatment for about 0.1 to 30 minutes to remove the dispersing agent and create the functional path. In some embodiments, the composition layer can be subjected to plasma treatment for 0.2 to 2 minutes. In other embodiments, the composition layer can be subjected to plasma treatment for 0.5 to 5 minutes. The composition layer can be continuously or intermittently subjected to plasma treating. Duration of the gas plasma treatment together with the power may determine the energy delivered to the plasma chamber during treatment. In one embodiment, the gas(es), their pressure, the flow rate, power density, and voltage may be varied over time during the treating processes. In some embodiments, the source of energy used to generate the plasma gas can also provide induction heating of the composition layer. In some embodiments, the plasma gas is created such that a separate source of energy is needed for induction heating of the composition layer.

Any number of commercially available plasma gas systems are suitable for use with the present invention. One example of a commercially available plasma gas system is a Plasma-Preen System, model II 973, from Plasmatic System, Inc., which uses microwave energy to generate the plasma. Another example of a commercially available plasma gas system is a reactive ion chamber PE/PECVD System 1000, from SEMI Group, which uses radio frequency energy to generate the plasma. In one embodiment for plasma treating, the plasma is created in capacitively-coupled plasma etchers, called reactive ion etchers (RIE), in which the typical pressure range of operation is between 10 mTorr and 1 Torr. To operate at lower pressures, down to 1 mTorr, the applied power needed would be very high, with an attendant high sheath voltage. This causes severe ion bombardment of the layer of the particulate composition on the substrate surface. To decouple the bias voltage on the substrate from the applied power needed to create and maintain the plasma, inductively-coupled plasma (ICP) systems become necessary. In ICP systems, the plasma is generated via a resonant inductive coil in an upper section of a chamber. Below, in the same chamber, the substrate is placed on a pedestal, which can be powered separately using another power supply. A set of solenoids can also be used in the upper chamber to confine the electrons and adjust the conductivity of the plasma, producing a uniform plasma in the upper chamber at pressures in the range 1 to 50 mTorr. The degree of ionization and activation can be very high, producing a very reactive plasma. In the lower chamber, the substrate pedestal can either be unpowered or powered, depending on the sheath voltage desired.

In another embodiment for plasma treating, creates the plasma using a low pressure plasma generation technique with microwave cavities and microwave electron cyclotron resonance (uECR). ECR plasmas operate even below 1 mTorr, and ionization efficiencies are again very high, due to the resonance between the cyclotron frequency of the electron and the microwave excitation field. The substrate can also be independently biased using a power supply for increasing ion bombardment as desired.

Helicon plasma sources are also used in low pressure plasma treating. In this case radio frequency waves are generated from an antennae. A solenoid magnetic field is also applied in addition to the radio frequency (RF) field. Right hand circularly polarized helicon waves at a smaller wavelength than the RF waves pass through the plasma and ionize the gas.

Plasma treating as embodied in the inventive process can be extended to include any of these manifestations of the plasma, down to sub-millitorr pressure range.

In another embodiment, treating includes subjecting the particulate composition layer on the substrate to ozone gas in the presence of ultraviolet radiation. Ozone is an allotropic form of oxygen, which can be created by subjecting oxygen gas to electric discharge. Ultraviolet-ozone treatment uses a combination of ultraviolet irradiation and ozone to remove the dispersing agent from the particulate composition layer. Ozone in the presence of ultraviolet radiation with wavelengths from about 150 to about 300 nm, decomposes into oxygen molecules and atomic oxygen. Simultaneously, organic components are excited or dissociated by the ultraviolet radiation. The atomic oxygen is highly reactive and oxidizes the excited organic molecules of the dispersing agent to volatile products, such as carbon dioxide, water, nitrogen, etc., which removes the dispersing agent from the composition. In some embodiments, UV-ozone treating sufficiently removes the dispersing agents from the composition layer, and subsequent induction heating of the layer forms an operative or functional connection on the substrate. In some embodiments, it may be useful to conduct the induction heating of the layer at the same time or during UV-ozone treating.

In some embodiments the source of energy for exciting the gas to a pjasma state also is capable of heating the particulate on the substrate to cause the particulate to form an operative or functional connection on the substrate. In this embodiment, treating with charged gas and heating of the particulate occur at the same or substantially the same time. In particular when electromagnetic energy such as microwave energy or radio frequency energy is used to create the plasma, heating by induction of the particulate on the substrate occurs. Microwave energy is an electromagnetic wave having a wavelength typically between about 0.3 to about 30 centimeters, which corresponds to frequencies on the order of about 300 megahertz to about 20 gigahertz. It should be noted that there is no sharp boundaries distinguishing microwave energy from infrared and radio waves. Radio frequency energy is a frequency of coherent electromagnetic radiation between about 5 megahertz to about 300 megahertz. Induction heating is the increasing of temperature in a material by an induced electrical current. Induction heating can be produced when a high frequency alternating current is passed through a conductive coil. The high frequency alternating current, in turn, creates a high frequency magnetic field in the area of the coil, which induced eddy current and hysteresis current in metals, such as the particulate. Heating the particulate composition results from the resistance of the metal particulate to the passage of the currents. Induction heating is capable of selectively heating the particulate without significantly heating the substrate since in most embodiments the substrate is less sensitive to induced electromagnetic energy. In some embodiments, the composition layer can be continuously subjected to induction heating for a time sufficient to render the operative or functional connection in the particulate layer. In other embodiments, the composition layer can be subjected to induction heating for intermittent periods of time sufficient to render the operative or functional connection in the particulate layer. Intermittent induction heating, with interspersed with periods of non-heating, minimizes heating of the substrate while forming the operative connection in the layer of particulate. Each of the intermittent periods of induction heating can be the same or different periods of time. The rest periods interspersed between the periods of induction heating can be shorter, the same, or longer periods of time than the intermittent induction heating time/s. Intermittent induction heating can maintain the temperature of the substrate at a temperature less than the temperature at which the substrate deforms or distorts. Whether or not the composition layer on the substrate can be continuously or intermittently treated and/or induction heated is dependent, in part, upon the power of the induction energy and 10 location and position of the substrate in the chamber, as well as the materials of the particulate composition and substrate. In some embodiments, the substrate that is carrying the particulate layer or pattern can reside on a platform that is cooled while plasma treating, to cool the substrate and counter any heating of the substrate that may occur. In most embodiments, the platform is located in the chamber of the device for generating the plasma gas.

In embodiments where the particulate is a metal or metal-based material, induction heating forms an operative or functional, i.e., conductive, connection of the particulate on the substrate. Sintering is the forming of a coherent bonded mass by heating metal powders. In some embodiments, particularly for large particles of particulate, the particles sinter without melting. In some embodiments induction heating can melt the particles. An example of this embodiment is that silver particulate having particle size diameter of less than about 6 nm melt upon induction heating. It is contemplated that for other metal based particulate have the same or different particle size diameter may also melt upon induction heating. In effect induction heating sinters the particulate since the dispersing agents have been removed by treating. Induction heating also can melt the particulate when the diameter of metal particulate is nanometer sized less than ˜5nm.

A plasma system that generates the plasma with radio frequency energies, may provide two different heating mechanisms. One mechanism is through the simple bombardment of the substrate (and particulate composition layer) by the ions generated in the plasma and accelerated through the bias field. The second mechanism is through RF heating of the particulate composition, particularly when the particles are conductive, by the radio frequency field that excited the plasma. While not being bound to any particular theory, electromagnetic waves can be exponentially damped in the direction normal to the substrate surface. In the case where the frequency is well below optical frequencies, the skin depth, δ, or the depth at which the field has fallen off to 1/e of its value at the surface, may be approximated by:

δ=square root(2/ωgμ)

Where: ω=2πf
g=conductivity (˜3×10̂7 mhos/m for silver)
μ=permeability (˜47π×10̂−7 for silver)
f=frequency in hertz

This implies that the skin depth in an embodiment where the particulate is composed of silver at 13.5 MHz, is approximately 0.25 micron. Thus, in the case of a film appreciably thicker than a micron, only a fraction is being directly heated by the electric field. The equation shows that lower frequencies would result in a larger skin depth and more efficient heating. A possible alternative would be to heat the particulate that is composed of conducting particles in a high frequency magnetic field. Coupling of energy would be more efficient. However, a drawback may be the very high frequencies needed to efficiently excite eddy currents in a nanoscale particle.

In an alternate embodiment, it is contemplated that the creation of the plasma can be induced by other means such as, electrical discharges, direct currents, or other forms of electromagnetic radiation (than microwave or RF), and a separate source for induction heating can be associated with the treating unit to independently heat the particulate and form an operative connection on the substrate. In some embodiments treating with the charged gas and heating of the particulate can occur at the same time or can be offset by a period of time suitable to allow heating of the particulate to occur just after the removal of all or most of the dispersing agent.

### Patternwise Application of Particulate Composition

In some embodiments a stamp or printing form is provided for applying the particulate composition on the substrate, in order to form a pattern layer of particulate on the substrate. The pattern of the particulate on the substrate can provide an operative function to a component or device. In some embodiments, the stamp includes a relief structure with a raised surface and a recessed surface. Typically the relief structure will include a plurality of raised surfaces and a plurality of recessed surfaces. In some embodiments, the relief structure of the stamp forms a pattern of raised surfaces for printing the particulate on the substrate. In some embodiments, the raised surfaces of the relief structure of the stamp represent the pattern of the particulate that will ultimately be formed on the substrate, and the recessed surfaces represent the background or featureless areas on the substrate. In other embodiments, the recessed surfaces of the relief structure of the stamp represent the pattern of the particulate that will ultimately be formed on the substrate, and the raised surfaces represent the background or featureless areas on the substrate. In these embodiments, the particulate composition is directly transferred or printed to the substrate from the stamp.

In some embodiments, the relief structure of the stamp forms a pattern of raised surfaces for printing a mask material on a substrate and the particulate composition is applied on the substrate to at least areas not having the mask material. In these embodiments, the particulate composition can be applied to at least the open areas, or can be applied as a layer over the mask material pattern, by any method described above. In these embodiments, the mask material is transferred or printed to the substrate from the stamp, and the pattern of the particulate composition is (indirectly) created after removal of the mask material.

In some embodiments the stamp is composed of an elastomeric material or a composition that becomes elastomeric as a result of molding or curing with heat or radiation. The particulate composition in the direct printing embodiments, and the mask material in the indirect printing embodiments, can be applied to at least the raised surface of the relief structure of the stamp by any suitable method, including but not limited to, injection, pouring, liquid casting, jetting, immersion, spraying, vapor deposition, and coating. Examples of suitable methods of coating include spin coating, dip coating, slot coating, roller coating, and doctor blading. The particulate composition or the mask material should be capable of forming a layer on at least the raised surface of the relief structure of stamp. Certain properties of the elastomeric stamp, such as, the solvent resistance of the stamp material, as well as certain properties of the mask material or the composition of the functional material, such as, the boiling point of a solvent and solubility of the functional material in the solvent, may influence the capability of a particular mask material or functional material to form a layer and transfer as a pattern to the substrate, but it is well within the skill of those in the art of microcontact printing to determine an appropriate combination of functional material and elastomeric stamp.

In one embodiment, the particulate composition or mask material is applied to the stamp and forms a layer on the relief structure of the stamp, that is, the particulate composition or mask material forms a layer on the raised surface/s and the recessed surface/s. The layer of particulate composition or mask material on the stamp can be continuous or discontinuous. The thickness of the layer of mask material is not particularly limited, provided that the material can print and function as a mask on the substrate. In one embodiment, the thickness of the mask material layer is typically less than the relief height (difference between the raised surface and the recessed surface) of the stamp. In one embodiment, the layer of mask material on the stamp is between 0.01 and 1 microns. The thickness of the layer of particulate composition on the stamp is not particularly limited, provided that the layer of particulate composition that transfers to the substrate equals or is less than about 200 nm.

After the particulate composition or the mask material has been applied to at least the raised surface of the stamp, the particulate composition or mask material may optionally be dried to remove some or all of a carrier or solvent prior to transferring to the substrate. Drying may be accomplished in any manner, including, using gas jets, blotting with an absorbent material, evaporation at room temperature or an elevated temperature, etc. In one embodiment the particulate composition or the mask material is substantially free of solvent or carrier before transferring and forms a film on the raised surface.

Effective drying can be aided by selecting a solvent for the functional material that has a relatively low boiling point and/or by application of very thin layer (i.e., less than about 1 micron) of the composition of the functional material. The liquid is sufficiently removed from the composition layer provided that a pattern of the functional material according to the relief structure transfers to the substrate. In one embodiment, the film of the functional material on the stamp has a thickness between 0.001 and 2 micron. In another embodiment, the film layer of functional material on the stamp has a thickness between 0.01 to 1 micron.

The selection of mask material is driven by the functional material (i.e., particulate) that will ultimately be patterned. The mask material is typically dispersed or dissolved or suspended in solution for application to the stamp. The functional material is also typically dispersed or dissolved or suspended in solution for application to the substrate. The type of solution used for the functional material, whether an organic or aqueous or alcohol based compound, determines the mask material and the corresponding solution that the mask material is dispersed or dissolved or suspended in. The mask material should not use the same or substantially the same or similar solution that the functional material uses. The solution may be a solvent or may be a carrier compound sufficient for the contact printing of the functional material or mask material with an elastomeric stamp.

In particular embodiments, the solution for the mask material is incompatible or substantially incompatible with the solution of the functional material. That is, in one embodiment if the functional material is in solution with an organic compound, the mask material is selected to be incompatible or substantially incompatible with organic solutions, (i.e., the mask material is dispersed or dissolved or suspended in aqueous or alcohol solution). In one embodiment, if the functional material is in solution with an aqueous or alcohol compound, the mask material is selected to be incompatible or substantially incompatible with aqueous or alcohol solutions, (i.e., the mask material is dispersed or dissolved or suspended in an organic material). In one embodiment, the mask material and the functional material are incompatible or substantially incompatible, such that the functional material when applied on the pattern of mask material on the substrate, does not or substantially does not alter or disrupt or otherwise impact the pattern of mask material. In another embodiment, the mask material and the functional material are incompatible or substantially incompatible such that the functional material and the mask material do not intermingle or dissolve when adjacent to one another. Examples of altering or disrupting the pattern include dissolving or swelling the mask material and lifting the mask material from the substrate (when in contact with the functional material); and dissolving or swelling the functional material and lifting of the functional material from the substrate. It is also contemplated that the mask material and the functional material both may use the same generic solution, e.g., both use an organic solution, or both use an alcohol solution, and still be incompatible or substantially incompatible. In this case provided that the solubility of the mask material solution and the functional material solution are different enough that the application of the functional material does not detrimentally impact the pattern of mask material on the substrate, and the removal of the mask material does not detrimentally impact the formation of the pattern of functional material, the mask material and the functional material are considered substantially incompatible. The mask material should be capable of (1) forming a layer on at least the raised surface of the relief structure of stamp; (2) transferring a pattern according to the relief structure to the substrate; and (3) removing from the substrate without detrimentally impacting the pattern of functional material (and without impacting an underlying layer, if present). Certain properties of the elastomeric stamp, may influence the capability of a particular mask material to form a layer and transfer to the substrate, but it is well within the skill of those in the art of microcontact printing to determine an appropriate combination of mask material and elastomeric stamp. In one embodiment, the mask material also allows the functional material to cover in whole or in part the mask pattern.

Materials suitable as the mask material are not limited provided that the mask material meets the above requirements. Examples of materials suitable for use as the mask material (for functional materials that are in aqueous or water solution), include but are not limited to, acrylonitrile homopolymers and copolymers, such as acrylonitrile-butadiene elastomers, and poly(acrylonitrile); styrene homopolymers and copolymers, such as, polystyrene, and poly(styrene-acrylonitrile) copolymers; homopolymers and copolymers of acrylates and methacrylates, such as polyacrylate, poly(ethyl methacrylate), and polymethacrylate; polycarbonates; polyurethanes; polythiophenes; substituted and unsubstituted polyphenylene-vinylene homopolymers and copolymers; poly(4-vinyl pyridine); poly(n-hexyl isocyanate); poly(1,4-phenylene vinylene); epoxy-based systems; poly(n-carbazole); homopolymers and copolymers of polynorbomene; poly(phenylene oxide); poly(phenylene sulfide); poly(tetrafluoroethylene); and combinations and copolymers thereof.

Examples of materials suitable for use as the mask material (for functional materials that are in organic solution), include but are not limited to, alkyd resins; gelatin; poly(acrylic acid); polypeptides; proteins; poly(vinyl pyridine); poly(vinyl pyrrolidone); hydroxy polystyrene; poly(vinyl alcohol); polyethylene glycol; chitosan; poly(styrene-co-vinyl pyridine); poly(butyl acrylate-co-vinyl pyridine); aryl amines and fluorinated aryl amines; cellulose and cellulose derivatives; dispersions of acrylate and/or methacrylate emulsions; and combinations and copolymers thereof.

Transferring the mask material from the raised surface of the relief structure to the substrate creates a pattern of the mask material on the substrate and correspondingly forms a pattern of open area on the substrate. Transferring may also be referred to as printing. Contacting the mask material on the raised surface to the substrate transfers the mask material, such that the pattern of mask material forms when the stamp is separated from the substrate. In one embodiment, all or substantially all the mask material positioned on the raised surface(s) transfer to the substrate. Transferring the particulate composition from the raised surface of the relief structure to the substrate creates a pattern of the particulate composition on the substrate. Contacting the particulate composition on the raised surface to the substrate transfers the particulate composition forming a pattern on the substrate when the stamp is separated from the substrate. In one embodiment, all or substantially all the particulate composition positioned on the raised surface(s) transfer to the substrate.

Optionally, pressure may be applied to the stamp to assure contact and complete transfer of the functional material or the mask material to the substrate. Suitable pressure used to transfer the material to the substrate is less than 5 lbs./cm², preferably less than 1 lbs./cm², more preferably 0.1 to 0.9 lbs./cm², and most preferably about 0.5 lbs./cm². Transfer of the material to the substrate may be accomplished in any manner. Transferring the material may be by moving the relief surface of the stamp to the substrate, or by moving the substrate to the relief surface of the stamp, or by moving both the substrate and the relief surface into contact. In one embodiment, the material is transferred manually. In another embodiment, the transfer of the material is automated, such as, for example, by a conveyor belt; reel-to-reel process; directly-driven moving fixtures or pallets; chain, belt or gear-driven fixtures or pallets; a frictional roller; printing press; or a rotary apparatus.

The separation of the stamp from the substrate may be accomplished by any suitable means, including but not limited to peeling, gas jets, liquid jets, mechanical devices etc.

In embodiments using the mask material, after the pattern of mask material is formed on the substrate, the functional material (i.e., particulate composition) is applied to the substrate, in at least the open area or areas between the mask pattern. In one embodiment, the functional material is applied to cover the surface of the substrate, that is, over the mask pattern and the open area/s on the substrate. In another embodiment, the functional material is applied selectively to cover at least the open area or areas on the substrate (where no pattern of mask material resides). The functional material can be applied to the substrate by any suitable method described previously.

In embodiments in which the particulate composition is directly printed pattern-wise, after the particulate composition has been applied to the substrate, the particulate composition can be dried to remove some or all of the liquid (solvent or carrier) prior to subsequent steps, such as removal of the mask pattern from the substrate, and treating. Drying may be accomplished in any manner, including, using gas jets, blotting with an absorbent material, evaporation at room temperature or an elevated temperature, etc. In one embodiment, the particulate composition is substantially free liquid and forms a film on the surface of the substrate. The pattern of particulate composition on the substrate is then treated with charged gas to remove the dispersing agent and induction heating to form functionalized paths of the particulate on the substrate.

In certain embodiments, after the functional material is applied to the substrate and forms a film, the mask pattern is removed from the substrate. Removing the pattern of the mask material can be accomplished by any method including, but not limited to, immersion or wetting with a solvent solution, exposure to laser radiation, and by contacting an adhesive to an exterior surface and separating the adhesive from the substrate to transfer the mask material from the substrate. Removal by the solvent may cause the mask pattern in whole or in part to lift, swell, dissolve, disperse, or combinations thereof into the solvent solution. Optionally, the removal of the mask material may be aided by sonication, that is, the application of intense sound waves to the solvent solution. In embodiments of removing the mask material with the adhesive, the adhesive has sufficient strength to overcome adhesive force at an interface between the mask material and the substrate and transfer the mask material from the substrate, but not so much strength as to overcome adhesive force at an interface between the functional material and the substrate and transfer the pattern of functional material, upon separation of the adhesive from the substrate. The adhesive is capable of removing all of the mask material in one or more repetitions of contacting the exterior surface and separating from the substrate.

The functional material that covers in whole or in part the pattern of mask material may be removed at the same time as the mask material or may be removed separately from removal of the mask material. Removal of the mask material should not disrupt or disturb the functional material that is in contact with the substrate (or with an underlying layer that is not the mask material). If the application of the functional material formed a layer on the substrate over both the mask pattern and the open area/s on the substrate, the removal of the mask pattern (and the overlying functional material) results in the formation of the pattern of the functional material on the substrate.

In embodiments in which the functional material is applied selectively to cover at least the open area or areas on the substrate (where no pattern bf mask material resides), treating with the charged gas and induction heating of the functional material on the substrate can occur in the presence or absence of the mask material.

### Stamp

The stamp may be formed in conventional fashion as understood by those skilled in the art of microcontact printing. For example, a stamp may be fabricated by molding and curing a layer of a material on a master having a surface presenting a relief form (that is in opposite of the stamp relief structure). The stamp may be cured by exposure to actinic radiation, heating, or combinations thereof. In some embodiments, the stamp includes a layer of the elastomeric material, which may be referred to as an elastomeric layer, cured layer, or cured elastomeric layer. The stamp may also, for example, be fabricated by ablating or engraving a material in a manner that generates the relief structure. The relief structure of the stamp is such that the raised surface has a height from the recessed surface sufficient for selective contact of the raised surface with a substrate. The height from the recessed surface to the raised surface may also be called a relief depth. In one embodiment, the raised surface has a height from the recessed surface of about 0.2 to 20 micron. In another embodiment, the raised surface has a height from the recessed surface of about 0.2 to 2 micron. The elastomeric layer forming the stamp has a thickness that is not particularly limited provided that the relief structure can be formed in the layer for printing. In one embodiment, the thickness of the elastomeric layer is between 1 to 51 micron. In another embodiment, the thickness of the elastomeric layer is between 5 to 25 micron.

In some embodiments, the stamp has an elastomeric layer having a modulus of elasticity less than 10 MegaPascals. In some embodiments of the stamp having the elastomeric layer provides the resulting stamp with a modulus of elasticity of at least 10 MegaPascal, and preferably greater than 10 MegaPascal. The modulus of elasticity is a ratio of an increment of stress to an increment of strain. For the present method the modulus of elasticity is the Young's modulus where at low strains the relationship between stress and strain is linear, such that a material can recover from stress and strain. The modulus of elasticity may also be referred to as coefficient of elasticity, elasticity modulus, or elastic modulus. The modulus of elasticity is a mechanical property well known to those of ordinary skill. A description of the modulus of elasticity and other mechanical properties of materials, and analysis thereof, can be found in Marks' Standard Handbook for Mechanical Engineers, eds. Avalone, E. and Baumeister III, T., 9^{th} edition, Chapter 5, McGraw Hill, 1987. A suitable method for determining the modulus of elasticity of the elastomeric stamp is described by Oliver and Pharr in J. Mater. Res. 7, 1564 (1992). This method is particularly suited for determining the modulus of elasticity for a thin elastomeric layer, such as the elastomeric layer forming the stamp that is less than 51 micron thick. The modulus of elasticity for the printing stamp can be measured on an indentation tester (Indenter) equipped with an indenter tip that is normal to a sample surface and having a known geometry. The indenter tip is driven into the sample by applying an increasing load up to some preset value. The load is then gradually decreased until partial or complete relaxation of the sample has occurred. Multiple sets of indentations in the sample can be done. The load/unload and displacement are recorded continuously throughout the test process to produce a load displacement curve from which mechanical properties, such as the modulus of elasticity and others, can be determined. The analysis of the load/unload curves for each indentation is conducted according to the method described by Oliver and Pharr originally introduced in the J. Mater. Res.

The material forming the stamp is elastomeric in order for at least a raised portion of the stamp to conform to a surface of the substrate so as to promote the complete transfer of the particulate thereto. In some embodiments, an elastomeric stamp having a modulus of elasticity of at least 10 MegaPascal (Mpa), is used to provide the capability to form features of particulate on the substrate of less than 50 micron resolution, particularly by direct contact printing. In one embodiment, the elastomeric stamp has a modulus of elasticity of at least 11 MegaPascal. In one embodiment, the elastomeric stamp has a modulus of elasticity of at least 15 MegaPascal. In another embodiment, the elastomeric stamp has a modulus of elasticity of at least 20 MegaPascal. In another embodiment, the elastomeric stamp has a modulus of elasticity of at least 40 MegaPascal.

The stamp can be fabricated from any material or combination of materials that is capable of reproducing by relief printing a pattern of particulate on the substrate. Polymeric materials suitable for forming the elastomeric stamp include, but are not limited to, for example, fluoropolymers; fluorinated compounds capable of polymerization; epoxy polymers, polymers of conjugated diolefin hydrocarbons, including polyisoprene, 1,2-polybutadiene, 1,4-polybutadiene, and butadiene/acrylonitrile; elastomeric block copolymers of an A-B-A type block copolymer, where A represents a non-elastomeric block, preferably a vinyl polymer and most preferably polystyrene, and B represents an elastomeric block, preferably polybutadiene or polyisoprene; and acrylate polymers. Examples of A-B-A block copolymers include but is not limited to poly(styrene-butadiene-styrene) and poly(styrene-isoprene-styrene). Another material suitable for forming an elastomeric stamp includes silicone polymers, such as polydimethylsiloxane (PDMS). Selection of the material used for the elastomeric stamp may in part be dependent upon the composition of the functional material and the liquid being applied to/by the stamp. For example, the material selected for the elastomeric stamp should be resistant to swelling while in contact with the composition, and in particular, the liquid. Fluoropolymers are typically resistant to organic solvents (for the functional material). Certain solvents, such as chloroform, used with the functional material tend to swell silicone based stamps, such as PDMS. Swelling of the stamp will alter the capability to produce fine resolution patterns on the substrate. The polymeric material may be elastomeric or may become elastomeric upon curing. The polymeric material may itself be photosensitive and/or the polymeric material may be included with one or more additives in a composition to render the composition photosensitive.

In one embodiment, the material forming the elastomeric stamp is photosensitive such that the relief structure can be formed upon exposure to actinic radiation. The term “photosensitive” encompasses any system in which the photosensitive composition is capable of initiating a reaction or reactions, particularly photochemical reactions, upon response to actinic radiation. Upon exposure to actinic radiation, chain propagated polymerization of a monomer and/or oligomer is induced by either a condensation mechanism or by free radical addition polymerization. While all photopolymerizable mechanisms are contemplated, photosensitive compositions useful as elastomeric stamp material will be described in the context of free-radical initiated addition polymerization of monomers and/or oligomers having one or more terminal ethylenically unsaturated groups. In this context, the photoinitiator system when exposed to actinic radiation can act as a source of free radicals needed to initiate polymerization of the monomer and/or oligomer.

The composition is photosensitive since the composition contains a compound having at least one ethylenically unsaturated group capable of forming a polymer by photoinitiated addition polymerization. The photosensitive composition may also contain an initiating system activated by actinic radiation to induce photopolymerization. The polymerizable compound may have non-terminal ethylenically unsaturated groups, and/or the composition may contain one or more other components, such as a monomer, that promote crosslinking. As such, the term “photopolymerizable” is intended to encompass systems that are photopolymerizable, photocrosslinkable, or both. As used herein, photopolymerization may also be referred to as curing. The photosensitive composition forming the elastomeric stamp may include one or more constituents and/or additives, and can include, but is not limited to photoinitiators, one or more ethylenically unsaturated compounds (which may be referred to as monomers), fillers, surfactants, thermal polymerization inhibitors, processing aids, antioxidants, photosensitizers, and the like to stabilize or otherwise enhance the composition.

The photoinitiator can be any single compound or combination of compounds, which is sensitive to actinic radiation, generating free radicals which initiate the polymerization without excessive termination. Any of the known classes of photoinitiators, particularly free radical photoinitiators such as but not limited to, ketones, quinones, benzophenones, benzoin ethers, peroxides, biimidazoles, trimethylbenzoyl phosphine oxide derivatives, and Michler's ketone may be used. In one embodiment, the photoinitiator can include a fluorinated photoinitiator that is based on known fluorine-free photoinitiators of the aromatic ketone type. Alternatively, the photoinitiator may be a mixture of compounds, one of which provides the free radicals when caused to do so by a sensitizer activated by radiation. Liquid photoinitiators are particularly suitable since they disperse well in the composition. Preferably, the initiator is sensitive to ultraviolet radiation. Photoinitiators are generally present in amounts from 0.001% to 10.0% based on the weight of the photosensitive composition.

Monomers that can be used in the composition activated by actinic radiation are well known in the art, and include, but are not limited to, addition-polymerization ethylenically unsaturated compounds. The addition polymerization compound may also be an oligomer, and can be a single or a mixture of oligomers. The composition can contain a single monomer or a combination of monomers. The monomer compound capable of addition polymerization can be present in an amount less than 5%, preferably less than 3%, by weight of the composition.

In one embodiment the elastomeric stamp is composed of a photosensitive composition that includes a fluorinated compound that polymerizes upon exposure to actinic radiation to form a fluorinated elastomeric-based material. Suitable elastomeric-based fluorinated compounds include, but are not limited to, perfluoropolyethers, fluoroolefins, fluorinated thermoplastic elastomers, fluorinated epoxy resins, fluorinated monomers and fluorinated oligomers that can be polymerized or crosslinked by a polymerization reaction. In one embodiment, the fluorinated compound has one or more terminal ethylenically unsaturated groups that react to polymerize and form the fluorinated elastomeric material. The elastomeric-based fluorinated compounds can be homopolymerized or copolymerized with polymers such as polyurethanes, polyacrylates, polyesters, polysiloxanes, polyamides, and others, to attain desired characteristics of the printing form precursor and/or the stamp suitable for its use. Exposure to the actinic radiation is sufficient to polymerize the fluorinated compound and render its use as a printing stamp, such that application of high pressure and/or elevated temperatures above room temperature is not necessary. An advantage of compositions containing fluorinated compounds that cure by exposure to actinic radiation is that the composition cures relatively quickly (e.g., in a minutes or less) and has a simple process development, particularly when compared to compositions that thermally cure such as PDMS based systems.

In one embodiment, the elastomeric stamp includes a layer of the photosensitive composition wherein the fluorinated compound is a perfluoropolyether (PFPE) compound. A perfluoropolyether compound is a compound that includes at least a primary proportion of perfluoroether segments, i.e., perfluoropolyether. The primary proportion of perfluoroether segments present in the PFPE compound is equal to or greater than 80 weight percent, based on the total weight of the PFPE compound. The perfluoropolyether compound may also include one or more extending segments that are hydrocarbons or hydrocarbon ethers that are not fluorinated; and/or, are hydrocarbons or hydrocarbon ethers that may be fluorinated but are not perfluorinated. In one embodiment, the perfluoropolyether compound includes at least the primary proportion of perfluoropolyether segments and terminal photoreactive segments, and optionally extending segments of hydrocarbon that are not fluorinated. The perfluoropolyether compound is functionalized with one or more terminal ethylenically unsaturated groups that render the compound reactive to the actinic radiation (i.e., photoreactive segments). The photoreactive segments may also be referred to as photopolymerizable segments.

The perfluoropolyether compound is not limited, and includes linear and branched structures, with linear backbone structures of the perfluoropolyether compound being preferred. The PFPE compound may be monomeric, but typically is oligomeric and a liquid at room temperature. The perfluoropolyether compound may be considered an oligomeric difunctional monomer having oligomeric perfluoroether segments. Perfluoropolyether compounds photochemically polymerize to yield the elastomeric layer of the stamp. An advantage of the PFPE based materials is that PFPEs are highly fluorinated and resist swelling by organic solvents, such as methylene chloride, chloroform, tetrahydrofuran, toluene, hexanes, and acetonitrile among others, which are desirable for use in microcontact printing techniques.

Optionally, the elastomeric stamp may include a support of a flexible film, and preferably a flexible polymeric film. The flexible support is capable of conforming or substantially conforming the elastomeric relief surface of the stamp to a printable electronic substrate, without warping or distortion. The support is also sufficiently flexible to be able to bend with the elastomeric layer of the stamp while peeling the stamp from the master. The support can be any polymeric material that forms a film that is non-reactive and remains stable throughout conditions for making and using the stamp. Examples of suitable film supports include cellulosic films such as triacetyl cellulose; and thermoplastic materials such as polyolefins, polycarbonates, polyimides, and polyester. Preferred are films of polyethylene, such as polyethylene terephthalate and polyethylene napthalate. Also encompassed within a support is a flexible glass. Typically the support has a thickness between 2 to 50 mils (0.0051 to 0.13 cm). Typically the support is in the form of a sheet film, but is not limited to this form. In one embodiment, the support is transparent or substantially transparent to the actinic radiation at which the photosensitive composition polymerizes.

Optionally, the elastomeric stamp may include one or more layers on the relief surface prior to the application of the particulate. The one or more layers may, for example, assist in the transfer of the particulate from the stamp to the substrate. An example of a material suitable for use as the additional layer includes fluorinated compounds. In one embodiment, the additional layer remains with the elastomeric stamp after transfer of the particulate to the substrate.

### Non-Patternwise Application of Particulate Composition

In some embodiments, the particulate composition may be applied as a layer to the substrate, and the pattern formed with the use of a photoresist. The particulate composition can form a layer on the substrate by any suitable method as described above. Photoresists are photosensitive films used for the transfer of images to a substrate. A layer of a photoresist is formed on a substrate and the photoresist layer is then exposed through a photomask to a source of activating radiation. The photomask has areas that are opaque to the activating radiation and other areas that are transparent to activating radiation. Exposure to activating radiation provides a photoinduced chemical or physical transformation of the photoresist layer to thereby transfer the pattern of the photomask to the photoresist-coated substrate. The photoresist can be developed in a suitable developer to provide an image that permits selective processing of a substrate. Photoresists are well known photosensitive compositions and are useful in the formation of printed circuit materials, in the formation of lithographic printing plates, and in proofing applications. The use of conventional photoresists for preparing photocircuits is described in “Photoresist—Materials And Processes”, by W. S. DeForest, published by McGraw-Hill, Inc. in 1975;and in “Printed Circuits Handbook”, edited by Clyde F. Coombs, Jr., McGraw-Hill, 1988 (3rd edition).

The photoresist composition for use in the present invention is not particularly limited, provided that the photoresist can form a suitable pattern layer disposed above the layer of particulate-covered substrate. The photoresist composition should also be sufficiently resistant to the charged gas plasma such that the region of the particulate layer covered by the photoresist pattern is protected from treatment by the charged gas plasma. Suitable photoresist compositions include negative-working photopolymerizable and photocrosslinkable or dimerizable systems as well as positive-working photosolubilizable systems. In positive-working systems, the areas exposed to actinic radiation are removed in the post-exposure processing (i.e., developing) step; in negative-working systems, the areas not exposed to actinic radiation are removed. In negative-working systems, exposure to actinic radiation initiates polymerization and/or crosslinking reactions, resulting in insolubilization of the material in suitable developer solvents. Photoresist compositions generally contain a binder, a monomeric or oligomeric material capable of polymerizing and/or cross-linking, and a photoinitiator. The photoresist can be applied as a liquid composition or as a dry film to the particulate layer on the substrate. Liquid photoresists may include a liquid carrier that is removed after application to the particulate coated substrate. Dry film resists can be applied as a solid (dry film) coating layer to the particulate coated substrate. A typical dry film contains a base or carrier sheet over which is coated a photoimageable composition with subsequent removal of the composition liquid carrier. Polyethylene terephthalate (PET) is a common carrier sheet for the dry film resist. The photoresist can be an aqueous-developable or aqueous-processable or a solvent-developable composition. The photoresist may be chemically-amplified resist in which the exposure to actinic radiation creates secondary chemical reaction that is responsible for the change in solubility, and therefore uses the available radiation very efficiently.

In the present invention, the photoresist is applied to the layer of particulate composition on the substrate, and exposed imagewise through a photomask to actinic radiation. The thickness of the layer of the photoresist is not limited, but typically is in the range of 1 to 5 microns. If the layer of the photoresist is too thin, the photoresist may be completely removed by the charged gas plasma and thus not provide sufficient protection to the underlying particulate layer. If the layer of photoresist is too thick, it may be difficult for the charged gas plasma to remove the dispersing agent from the particulate layer at or along edges of the photoresist pattern which can result in poor resolution of the functional pattern in the particulate layer. The photoresist is then developed in a suitable developer to provide an image of the desired pattern on or disposed above the layer of particulate composition on the substrate, and creates corresponding areas open to the particulate composition layer. The substrate having the layer of the particulate composition with the pattern of photoresist is then treated and heated. The particulate layer not covered by the pattern of resist, i.e., open areas, is treated with the charged gas to remove the dispersing agent from the composition layer and induction heated to form the operative connection, i.e., functionalize, of the particulate. The particulate covered by the pattern of resist is essentially not impacted by the treating and heating. It should be noted that treating with the charged gas plasma may cause removal of (some portion) the photoresist material. However, this is acceptable provided that the pattern of photoresist remains intact for the period of time sufficient to treat the particulate layer to remove the dispersing agent and form the operative connection of the particulate. Appropriate selection of photoresist material and application of the photoresist to a suitable layer thickness will lessen the impact of the charged gas plasma on the photoresist. After treating with the charged gas, the pattern of photoresist can be removed by conventional photoresist removal methods or by washout.

In some other embodiments, the particulate composition may be applied as a layer to the substrate, and the pattern formed with the application of a polymeric material disposed above or on the layer of the particulate composition. The layer of the particulate composition can be formed on the substrate by any suitable method as described above. A stamp or printing form, such as those described above, applies the polymeric material pattern-wise on or above the layer of the particulate composition. The polymeric material can also be referred to as a mask material. The polymeric material should be capable of (1) forming a layer on at least the raised surface of the relief structure of stamp; (2) transferring a pattern according to the relief structure to the particulate layer; (3) removing from the particulate layer without detrimentally impacting the particulate layer; and (4) resisting the charged gas plasma sufficiently such that the region of the particulate layer covered by the pattern of polymeric material is protected from treatment by the charged gas. Suitable polymeric materials include the materials suitable for use as the mask material (on the substrate) as described above. The conditions and application of the polymeric material to the particulate layer can be the same or substantially the same as the conditions and application set forth above for the application of the mask material to the substrate. The pattern of polymeric mask material on the particulate layer creates corresponding areas open to the particulate layer which are then treated with the charged gas to remove the dispersing agent from the layer and induction heated to form the operative connection, i.e., functionalize, of the particulate. The particulate covered by the pattern of polymeric material is essentially not impacted by the treating and heating. Treating with the charged gas plasma may cause removal of (some portion) the polymeric mask material. However, this is acceptable provided that the pattern of polymeric material remains intact for the period of time sufficient to treat the particulate layer to remove the dispersing agent and form the operative connection of the particulate. The pattern of polymeric material can be removed by washout with an appropriate solvent or with an adhesive layer as described above.

In addition to the advantages of the present method that were mentioned above, the embodiment that uses a pattern of the photoresist or polymeric material disposed above the particulate layer to selectively treat the particulate layer with the charged gas and induction heating, also can have an advantage of making the functional pattern of the particulate in the particulate layer without the need to remove the non-treated portions of the particulate layer (that formerly were under the pattem of photoresist or polymeric material). That is after treating with the charged gas and induction heating, the particulate layer can remain intact (and appear as a continuous layer), yet the layer is composed of a pattern of functionalized particulate material (treated portions) and non-functionalized particulate material (non-treated portions) contiguous with the functionalized material.

In these embodiments in which the particulate layer remains intact and the non-treated portions of the particulate layer are not removed from the substrate, it is important that the non-functionalized (non-treated) portions of the layer of particulate do not have residual inherent functionality. Residual inherent functionality can be determined by testing for electrical properties such as resistivity, sheet resistance, etc. using a probe station. The residual inherent functionality may be a result of the closeness of the particulate and/or other factors after the liquid diluent is removed from the layer. The residual functionality in the particulate layer is not sufficient to render the particulate layer completely or substantially operational, but may be sufficient to interfere with the functionality of the pattern of adjacent functionalized (i.e., treated) portions of the layer. The particulate composition can be appropriately chosen and applied to the substrate such that the particulate in the layer are not functionally capable upon removal of the diluent. Particulate characteristics such as size, shape, and surface properties, the type and content of the dispersing agent and the liquid diluent, the concentration of the particulate in the composition, the application method and thickness of the layer of particulate composition are a few of the factors that can influence whether the layer of the particulate composition will have or not have residual inherent functionality. Yet this must be balanced against the need to be able to pattern-wise functionalize the layer of particulate composition upon treating with the charged gas and induction heating. In the embodiments in which the non-treated portions of the particulate layer will be removed from the substrate after treatment and induction heating, the inherent residual functionality of the particulate layer is not a concern. Similarly in embodiments described above in which the particulate composition is direct applied pattern-wise, the inherent residual functionality of the particulate layer is not a concern.

The present method provides a method to form a layer of a particulate on a substrate for use in devices and components in a variety of applications, including but no limited to, electronic, optical, sensory, and diagnostic applications. The method can be used to form a layer or patterns of active materials or inactive materials for use in electronic devices and components and in optical devices and components. Such electronic and optical devices and components include, but are not limited to radio frequency tags (RFID), sensors, and memory and backpanel displays. The method can be used to form patterns of conductive materials, semiconductive materials, dielectric materials on the substrate. The method can form the particulate into a pattern that forms barrier walls for cells or pixels to contain other materials, such as light emitting materials, color filter pigmented materials, or a pattern that defines the channel length between source and drain electrode delivered from solution. The pattern of barrier walls may also be referred to as a confinement layer or barrier layer. The method can form the particulate into a pattern that forms barrier walls that creates cells for use as color filter pixels. The color filter pixels can be filled with colorant materials for color filters, including pigmented colorants, dye colorants. The method can form the particulate into transistor channels for top gate devices in which other materials, such as source materials and drain materials, are delivered to the channels. The method can form the functional material into transistor channels on a semiconducting layer of the substrate for bottom gate devices in which source materials and drain materials are delivered to the channels. The other materials can be delivered into the cells on the substrate as a solution by any means, including ink jet.

### EXAMPLES

### Example 1

### Control

A Control sample was prepared. A silver ink, type DGP-MP-25LT 25C from ANP Co. Ltd. (Korea), was used as the particulate composition. The manufacturer reported that silver ink had a silver metal content of 25.1 weight % (solids content), a viscosity of 4.5 cP (as measured on Brookfield LVDV-1+), a dispersion matrix of a polar solvent of mixed alcohols, and curing conditions of 250° C. for 30-60 minute. The silver ink was composed of nanoparticles of silver having an average diameter of 30 nm, and a polyvinylpyrollidone (PVP) binder. The ink was diluted to 8% by weight with methanol. The diluted silver dispersion was then sonicated for 10 minutes with a tip sonicator and filtered twice with a 0.2 micron PTFE filter. The silver dispersion composition was spun coated onto a polyethylene terephthalate (PET) (type ST504, from DuPont Teijin Films) substrate at 3000 rpm for 60 seconds. The layer of silver dispersion was annealed at 65° C. for 2 minute on a hotplate to remove the solvent methanol. The layer of silver was lightly conductive after removal of the solvent (0.1 Siemens/cm ad described below).

The layer of silver nanoparticles on the substrate was analyzed. The resistivity of the silver film was measured using a 4 point probe of a probe station (model REL-6100, from Cascade Microtech Inc.) and analyzed using a Semiconductor Analyzer, model Agilent 4155C, from Agilent Technologies, (Santa Clara, Calif.). The sheet resistance of the silver layer was 1.6×10⁶Ω/□. A profiler meter was used to measure the thickness of silver film which was 63nm. Conductivity of the silver film was 0.1 Siemens/cm (S/cm). No distortion or deformation of the substrate was observed.

### Example 1A

For Example 1A, a sample of a layer of silver nanoparticles on a substrate was prepared according to the present invention using argon plasma treating and induction heating with microwave energy. The same silver ink was used and prepared as described in the Control through annealing at 65° C. for 2 minute on a hotplate to remove the solvent. The silver film on the substrate was placed on a stainless steel platform in a plasma chamber of a Plasma-Preen System, model II 973, from Plasmatic System, Inc. (North Brunswick, N.J.), which was operated with argon gas flow rate of 3.0 SCFH (standard cubic feet per hour) (1425 sccm (standard cubic centimeter per minute) and microwave (2.45GHz) power of 295 W (Watts) under vacuum condition (3Torr). The silver film on the substrate was then treated with argon plasma and microwave energy for 2 minutes, in 30 second increments interspersed with 30 second rest of no treating by turning the microwave power on and off, for a total time of 4 minutes. The temperature of the platform was maintained at 20° C. using a chiller circulator Coolflow CFT-33, from Thermo-NESLAB Inc., (Portsmouth, N.H.).

The sample was analyzed as described above. The sheet resistance of silver film was 3.4Ω/□. The thickness of silver film was 60 nm. The conductivity of silver film became 5.0×10⁴S/cm. No distortion or deformation of the substrate was observed.

### Example 1 B

For Example 1 B, a sample of a layer of silver nanoparticles on a substrate was prepared according to the present invention using oxygen plasma and microwave treatment. The same silver ink was used and prepared as described in the Control through annealing at 65° C. for 2 minute on a hotplate to remove the solvent. The silver film on the substrate was treated with oxygen plasma and microwave for 2 minutes as described in Example 1A, except that the chamber operated with oxygen gas flow rate of 3.0 SCFH (standard cubic feet per hour) and microwave (2.45GHz) power of 588 W (Watts) under vacuum condition (3 Torr). The sample was treated and heated while located on the cooled platform.

The sample was analyzed as described above. The sheet resistance of the silver film was 0.64Ω/□. The thickness of the silver film was 70 nm. Conductivity of the silver film was 2.2×10⁵ S/cm. No distortion or deformation of the substrate was observed.

### Example 1C

For Example 1C, a sample of a layer of silver nanoparticles on a substrate was prepared according to the present invention using argon plasma and radio frequency (RF) treatment. A silver ink, type DGP-MP-40LT 25C from ANP Co. Ltd. (Korea) was used as the particulate composition. The manufacturer reported that the silver ink had a silver metal content of 40.7 weight % (solids content), a viscosity of 14.3cP (as measured on Brookfield LVDV-1+), a dispersion matrix of a polar solvent of mixed alcohols, and curing conditions of 250° C. for 30-60 minute. The silver ink was composed of nanoparticles of silver having an average diameter of 50 nm, and a polyvinylpyrollidone (PVP) binder. The ink was diluted to 10% by weight with ethanol. The diluted silver dispersion was then sonicated for 10 minutes with a tip sonicator and filtered twice with a 0.2 micron PTFE filter. The silver dispersion composition was spun coated onto a polyethylene terephthalate (PET) (type ST504, from DuPont Teijin Films) substrate at 3000 rpm for 60 seconds. The layer of silver dispersion was annealed at 65° C. for 2 minute on a hotplate to remove the solvent ethanol. The layer of silver was tested as described in the Control and was lightly conductive after removal of the solvent. The silver film was treated with argon plasma and RF using reactive ion chamber (SemiGroup PE/PECVD System 1000) for 2 minutes continuously, with argon gas flow rate of 50 SCCM (standard cubic centimeter per minute) and RF (13.56 MHz) power of 500 W (Watts) under vacuum condition (0.3 Torr) in the plasma treating chamber.

The sample was analyzed as described above. The sheet resistance of the silver film was 2.67Ω/□. The thickness of the silver film was 70 nm. Conductivity of the silver film was 5.4×10⁴ S/cm. There was no deformation or distortion of PET film after plasma and RF treatment of the silver film.

### Comparative Example 1

For Comparative Example 1, several samples (identified as A through C) were prepared with the same silver ink that was used and prepared as described in the Control through annealing at 65° C. for 2 minute on a hotplate, followed by thermal sintering in a convection oven for 5 minutes at 140° C., 5 minutes at 210C, and 30 min at 210° C., respectively.

The samples for Comparative Example 1 sample were analyzed as described above, and the results are reported in the following table.

| | | Sheet | | |
|---|---|---|---|---|
| Comparative | | Resistance | Thickness | Conductivity |
| Example 1 | Treatment | (Ω/□) | (nm) | (S/cm) |
| Sample A | Treated @65° C. | 12.0 | 60 | 1.76 × 10⁴ |
| | for 2 min. and | | | |
| | thermal sintering | | | |
| | @140° C. | | | |
| | for 5 min. | | | |
| Sample B. | Treated @65° C. | 7.13 | 48.2 | 2.91 × 10⁴ |
| | for 2 min. and | | | |
| | thermal sintering | | | |
| | @210° C. | | | |
| | for 5 min. | | | |
| Sample C. | Treated @65° C. | 4.98 | 45.4 | 4.42 × 10⁴ |
| | for 2 min. and | | | |
| | thermal sintering | | | |
| | @210° C. | | | |
| | for 30 min. | | | |

After treatment, the PET substrate in Sample C became hazy. It is believed the haziness is due to oligomers leaching from the substrate. It was observed that both Samples B and C of Comparative Example 1 were deformed. The silver film sample of Example 1A that was treated with argon plasma and microwave energy and the silver film sample of Example 1 B had higher conductivity than the silver film Samples A through C of Comparative Example 1 that were treated by annealing and heating to sinter.

### Comparative Example 2

For Comparative Example 2, two samples (A and B) were prepared with the same silver ink and prepared as described in the Control through annealing at 65° C. for 2 minute on a hotplate, and followed by microwave treatment (2.45 GHz) with 295 W (Watts) for a continuous 2 minutes in the gas plasma unit of Example 1A, but no gas plasma treatment was used. Both Sample resided on the cooled metal platform in the chamber. Comparative Example 2A was microwave treated while under vacuum and Comparative Example 2B was microwave treated without vacuum.

The Samples of Comparative Example 2 were analyzed as described above. For Comparative Example 2A, the sheet resistance was infinite (there was no conductivity of the silver layer). For Comparative Example 2B, the sheet resistance of the silver film was 9.4×10⁴Ω/□. The thickness of the silver film was 64.7 nm. The conductivity of the silver film was 1.64 S/cm. Microwave treatment alone, without gas plasma treatment, exhibited a low conductivity. No deformation for the substrate was observed.

### Comparative Example 3

For Comparative Example 3, two samples (A and B) were prepared with the same silver ink and prepared as described in the Control through annealing at 65° C. for 2 minute on a hotplate. After annealing, Sample A and Sample B each was placed on a cooled platform in a UV Backflash Ozone Cleaning System, Model T10X10 Backflash OES, from UV OCS Operations, (Montgomery, Pa.) and treated with ultraviolet-ozone energy for 2 minutes continuously to remove the binder dispersing agent in the film of the silver ink. Sample B was then placed on a hot plate and heated to 180° C. for 5 min. to sinter the particulate.

The Samples of Comparative Example 3 were analyzed as described above, and the results are reported in the following table.

| | | Sheet | | |
|---|---|---|---|---|
| Comparative | | Resistance | Thickness | Conductivity |
| Example 3 | Treatment | (Ω/□) | (nm) | (S/cm) |
| Sample A | Treated @65° C. for | 5.2 × 10⁵ | 51 | 0.38 |
| | 2 min., and | | | |
| | UV-ozone treatment | | | |
| | for 2 min. | | | |
| Sample B | Treated @65° C. for | 11.6 | 42 | 2.06 × 10⁴ |
| | 2 min., UV-ozone | | | |
| | treatment for 2 min., | | | |
| | and then heating at | | | |
| | 180° C. for 5 min. | | | |

For Comparative Example 3 Sample A removing the binder of the silver ink with UV-ozone treatment alone, without induction heating such as with microwave energy, exhibited a low conductivity, that was not a significant increase in the conductivity compared to the conductivity of the Control. For Comparative Example 3 Sample B, the additional heating after 2 min. of UV-ozone treating did increase the conductivity. However, the resulting conductivity of the silver film for Sample B was still lower than the conductivity of the silver film of Example 1A that was treated with argon plasma and microwave energy and lower than the conductivity of the silver film of Example 1 B that was treated with oxygen plasma and microwave energy. It was observed however, that the substrate in Comparative Example 3 Sample B was deformed after heating. It is contemplated that if induction heating was conducted at the same time as UV-ozone treatment, that the conductivity of the layer of the particulate would be improved (compared to the conductivity of the Samples from Comparative Example 3).

From Example 1, treating the silver film on PET substrate using plasma gas (e.g., argon, or oxygen) and microwave heating at the same time, exhibited the highest conductivity performance when compared to the alternate comparative methods. Yet the polymeric film substrates did not deform or distort, in the Examples 1A and 1 B.

### Example 2

Several Samples of a pattern of silver nanoparticles was formed on a polymeric film. An elastomeric stamp was used to print a pattern of a mask material on the polymeric film, which is the opposite of the desired pattern of silver, the silver nanoparticle ink composition was applied on at least non-masked areas, and the mask material was removed. The silver nanoparticles were formed into a pattern onto a flexible polymeric film substrate that can provide a functional source-drain level of a thin film transistor.

### Master Preparation:

A thin hexamethyldisilazane layer (HMDS) (from Aldrich) was spun coated onto a 2 inch (5.1 cm) silicon wafer at 3000 rpm for 60 seconds. HMDS is an adhesion promoter for a photoresist material on a silicon wafer. A Shipley photoresist, type 1811 (from Rohm and Haas) was spun coated onto the HMDS layer at 3000 rpm for 60 seconds. The photoresist film was pre-baked on the hotplate at 115° C. for 1 minute to complete drying. The pre-baked photoresist film was then imagewise exposed to ultraviolet radiation of 365 nm for 8 seconds in an I-liner (OAI Mask Aligner, Model 200). After exposure the photoresist was developed in developer type MF-319 (from Rohm and Haas) that is tetramethyl ammonium hydroxide (TMAH) solution for 60 seconds. The developed film was washed in distilled water, dried with nitrogen, and heated on the hotplate to 115° C. for 5 minutes, to form the master with a relief pattern. The relief pattern on the prepared master had raised surface areas and recessed areas. The raised surface areas in the master form a positive image that will be the pattern of the functional silver material formed on the substrate. The thickness of the layer of the patterned photoresist master was 1.1 microns as measured with a surface Profiler (KLA-Tencor, San Jose, Calif.).

### Elastomeric Stamp Preparation

A support for the elastomeric stamp was prepared by applying a layer of a UV curable optically-clear adhesive, type NOA73, (purchased from Norland Products; Cranbury, N.J.) at a thickness of 5 microns onto a 5 mil (0.0127 cm) Melinex® 561 polyester film support by spin coating at 3000 rpm and then curing by exposure to ultraviolet radiation (350-400 nm) at 1.6 watts power (20 mWatt/cm²) for 90 seconds in a nitrogen environment.

A perfluoropolyether (PFPE) compound, D20-DA was supplied by Sartomer as product code NTX7068 and was used as received. The D20-DA has the following structure:

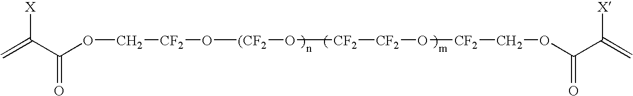

Where X and X′ are H, and m and n, which designate the number of randomly distributed perfluoromethyleneoxy (CF₂O) and perfluoroethyleneoxy (CF₂CF₂O) backbone repeating subunits, is such that the PFPE compound has a molecular weight of about 2000 based on a number average. The D20-DA is identified as a PFPE diacrylate prepolymer.

A fluorinated photoinitiator having the resulting structure was prepared according to the following reaction.

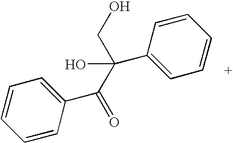

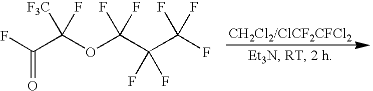

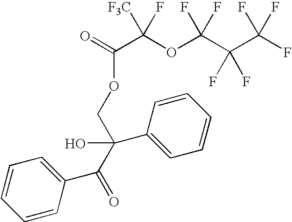

| | Fluorinated photoinitiator | | | | | |
|---|---|---|---|---|---|---|
| | | Molar | Reaction | | | |
| | | Mass | Mass | | Volume | |
| Compound | Structure | (g) | (g) | Moles | (mL) | Equiv. |
| Alpha- | C₁₅H₁₄O₃ | 242.27 | 20.00 | 0.083 | | 1.00 |
| hydroxymethylbenzoin | | | | | | |
| HFPO-dimer acid fluoride | C₆F₁₂O₂ | 332.044 | 32.89 | 0.099 | | 1.20 |
| Methylene Chloride | | | | | 100 | |
| Freon-113 | | | | | 60 | |
| Triethylamine | Et₃N | 101.19 | 8.35 | 0.083 | | 1.00 |
| Product | C₂₁H₁₃F₁₁O₅ | 554.307 | 45.76 | 0.083 | | |

### Procedure to Prepare the Fluorinated Photoinitiator:

To a 500 mL round bottom flask was added α-hydroxymethylbenzoin (20.14 g), triethylamine (Fluka, 8.40 g) and methylene chloride (100 mL). The mixture was magnetically stirred under positive nitrogen pressure at room temperature. To a separate flask was added HFPO dimer acid fluoride (32.98 g) and Freon-113 (CFCl₂CF₂Cl, Aldrich, 60 mL). The acid fluoride solution was added dropwise to the stirring α-hydroxymethylbenzoin solution at 4-5° C. over 30 minutes in order to control the exothermic reaction. The reaction pot stirred for 2.5 hrs at room temperature after the addition was complete.

The reaction was washed with 4×500 mL saturated NaCl solution. The organic layer was dried over MgSO₄ and filtered over a celite/methylene chloride pad. TLC analysis indicated a small amount of starting material remained in the crude product. The product was concentrated in vacuo and then dissolved in hexanes (100 mL). This solution was pre-absorbed onto silica gel and washed through a silica column using 90:10 hexanes:EtOAc eluent. The desired product was isolated as a light yellow oil which was a mixture of diastereomers (33 g, 72% yield).

The elastomeric stamp composition was prepared by mixing the PFPE diacrylate prepolymer (MW 2000) and 1% by weight of the 5 fluorinated photoinitiator. The mixture was filtered using a 0.45 micrometer PTFE filter. The filtered prepolymer was poured to form a layer on the side of the prepared master having the relief pattern. The support was placed on the PFPE pre-polymer layer opposite the master (air-layer interface), such that the adhesive was in contact with the layer. The PFPE layer was exposed through the support using the 365 nm I-liner (17 mW/cm²) for 10 minutes under a nitrogen atmosphere, to cure, or polymerize the PFPE layer and form a stamp. The stamp was then peeled from the master and had a relief surface that was the opposite of the relief pattern in the master. Thus the relief surface on the stamp was the 15 negative of the desired pattern of silver nanoparticles. (The stamp had raised surface areas and recessed areas, in which the recessed surface areas correspond to the pattern of silver that will ultimately be formed.)

### Transfer of Mask Material

A mask material of 0.5% by weight solution of Covion Super-Yellow™, a substituted polypheylene-vinylene 1-4 copolymer, (from Merck) was dissolved in toluene and filtered using a 1.5 micron PTFE filter. The mask material solution was spun coated onto the relief surface of the prepared PFPE stamp at 3000 rpm for 60 seconds. The solution covered the entire relief surface, and was allowed to dry in air at room temperature for about 1 minute. The substrate, a 5 mil Melinex® film type ST504, was placed on a hotplate maintained at 65° C. The PFPE stamp having the layer of the mask material was laminated onto an PET side of the substrate (while on the hotplate) without applying any additional pressure. The stamp and the substrate were removed from the hotplate, and the stamp was separated from the substrate at room temperature. The mask material on the raised surface of the relief pattern of the elastomeric stamp transferred to the substrate and formed a mask pattern on the substrate. Recessed areas in the stamp did not contact the substrate, and therefore the substrate had open areas where there was no mask material. The pattern of masking material had a thickness of 27 nm as measured with a profiler. The mask pattern of the printed sacrificial masking material was the positive of the pattern of the pattern on the master.

### Application of the Particulate Composition

A silver nanoparticle ink composition was prepared as described in the Control through filtration. The silver dispersion was spun coated onto the substrate having the pattern of the mask material at 3000 rpm for 60 seconds. The entire surface of the substrate was covered by the silver dispersion, that is, the silver material was deposited as a layer on the mask pattern and the open areas.

### Removing Mask Material

A material capture element having a layer of an adhesive was prepared by coating a polymeric latex having a glass transition temperature of 3.3° C. on a flexible film, 5 mil Melinex® film type ST504. The polymeric latex, 33% by weight solids was prepared by emulsion polymerization of 10% of glycidyl methacrylate, 2% of methyl acrylic acid, 80% of butyl methacrylate, and 8% of methylmethacrylate. The polymeric latex was an aqueous solution, and was diluted to 6.6% solids by adding 5 times of distilled water by weight and followed by filtering through 0.45 micron PTFE filter. Before spin coating, the coated side of ST504 film was oxygen plasma treated for 15sec using Plasma Preen Cleaner (Terra Universal, Inc., Fullerton, Calif. 92831) and washed with isopropyl alcohol, acetone, and distilled water, and dried using a nitrogen gun. The diluted latex solution was spin coated onto the ST504 film at 300 rpm for 60 sec. The spun-coated latex film on ST504 was annealed at 140° C. for 5min in a convection oven. The adhesive layer had a thickness of ˜100 nm and a roughness of ˜5 nm.

The substrate with the pattern of mask material and the layer of the silver functional material was placed on a hotplate at 65° C. The material capture element was oriented so that the adhesive latex layer was adjacent and in contact with the layer of the silver functional material, and then laminated at 130° C., 1 mm/sec using roll lamination equipment (Eagle35, General Binding Corporation) with even pressure to form an assemblage.

The material capture element was then peeled away from the substrate at 65° C., delaminating the assemblage, removing the mask material from the substrate and forming the pattern of the silver functional material on the substrate. The adhesive layer of the material capture element carried away the silver that resided on the mask material and the pattern of mask material together. The adhesive layer did not remove the silver functional material residing on the substrate, and the pattern of silver remained on the substrate.

Although the silver material was uniformly coated forming a layer onto the mask material, a high resolution silver pattern was created on the substrate. The highest resolution was 5 micron line width with 2 micron gaps.

### Treating

Each sample bearing the pattern of silver on the polymeric film substrate was treated as follows. The sample was analyzed as described above. The resistivity of the silver for each sample was measured on a same location of the pattern of silver on the substrate. The results are shown in the following table.

As a Control, one sample was heated to 65° C. to anneal and remove the solvent from the silver composition. As a Comparative, one sample was placed on a hot plate and heated to 140° C. for 1 minute to thermally sinter the silver nanoparticles. As Examples, three samples were subjected to argon plasma and microwave treatment as described in Example 1A, for different periods of time.

| | | Sheet resistance |
|---|---|---|
| Sample | Treatment | (ohm/sq.) |
| Control | Annealed at 65° C. for 2 min. | 150 |
| Example 2A | Argon plasma and microwave | 7 |
| | heating for 30 sec. | |
| Example 2B | Argon plasma and microwave | 5 |
| | heating for 60 sec. | |
| Example 2C | Argon plasma and microwave | 2.5 |
| | heating for 120 sec. | |
| Comparative | Heated to 140° C. for 1 min. | 45 |

The argon plasma and microwave heating treatment provided silver pattern with improved resistivity over the Control and the Comparative samples. As the argon plasma and microwave heating treatment time increased, the resistivity of the silver pattern decreased. Since the resistivity is inverse to the conductivity, once would anticipate that the conductivity would increase as the argon plasma and microwave heating treatment time increased. No deformation or distortion of the substrate used in each of samples for Examples 2A, 2B, and 2C was observed. No deformation or distortion of the substrate for the Comparative sample in Example 2 was observed.

It was observed that gas plasma treatment with induction heating, such as with microwave energy or radio frequency energy, of the silver nanoparticle ink exhibited lower sheet resistivity and thus higher conductivity compared to either only heat treated silver nanoparticle ink or UV-ozone treated silver nanoparticle inks. Gas plasma treating effectively removed the dispersing agent, such as the organic binders and/or surfactants, from between the nanoparticles, while at the same time the induction heating sintered the silver nanoparticles without any or observed deformation of polymeric film substrate.

### Example 3

A silver ink, type DGH-50LT 25C from ANP Co. Ltd. (Korea), was used as the particulate composition. The manufacturer reported that the silver ink had a metal content of 50.1 weight %, a viscosity of 2.0 cP (as measured by (Brookfield LVDV-1+), a dispersion matrix of toluene, and curing conditions of 250° C. for 30-60 minute. The ink was diluted to 13% by weight with toluene. The diluted silver dispersion was then sonicated for 10 minutes with a tip sonicator and filtered twice with a 0.2 micron PTFE filter. The silver dispersion composition was spun coated at 3000 rpm for 60 seconds onto a p-type silicone wafer having gold coated on its backside as a gate layer. The layer of silver dispersion was annealed at 65° C. for 2 minute and 115° C. for 1 minute on a hotplate to remove the solvent toluene. A positive photoresist composition (type S1811, from 1o Shiepley) was spun coated on top of the silver film at 3000 rpm for 60 seconds followed by pre-baking at 65° C. 120 seconds and 115° C. for 60 seconds. The silver layer was tested as described in the Control for Example 1 and the silver layer was not conductive after removal of the solvent.

A pattern was formed in the photoresist layer on the wafer by uv exposing the photoresist for 8 sec with glass photomask contacting top surface of the photoresist and followed by developing the exposed region in developer (MF-319, from Shiepley) for 20sec. The resulting wafer included the layer of silver composition, and the pattern of photoresist on the silver layer. The pattern of photoresist corresponded to the pattern of the source-drain that will be formed in the silver layer. The open source-drain patterns, i.e., the silver layer not covered by the pattern of photoresist, were plasma treated with argon gas flow to be conductive in a plasma chamber of a Plasma-Preen System, model II 973, from Plasmatic System, Inc. (North Brunswick, N.J.), which was operated with argon gas flow rate of 3.0 SCFH (standard cubic feet per hour) (1425 sccm (standard cubic centimeter per minute) and microwave (2.45 GHz) power of 295 W (Watts) for 3min and 588 W (Watts) for 2 min under vacuum condition (3 Torr ). The photoresist (pattern) remaining after plasma treatment was washed out using acetone. After argon plasma treatment, the layer of silver on the wafer had regions of conductive silver that were the open areas of the source-drain pattern not covered by the photoresist, and regions of non-conductive silver that were blocked by the photoresist during plasma treatment. The non-conductive regions of the silver layer remained with the conductive regions of the silver layer on the wafer.

### Octadecyltrichlorosilane (OTS) Treatment in Glove Box

The following treatment occurred in a glove box that was charged with nitrogen gas. The wafer with the layer of silver having conductive regions of the source-drain silver pattern and non-conductive regions was placed into the glove box. The 0.1M OTS solution in toluene was prepared by adding 1.62 ml of OTS in 30 ml of toluene in a wide mouth jar. The wafer was placed in the OTS solution for 20 minutes. After 20 minutes the wafer was removed and rinsed with toluene then dried off with an air gun. The wafer was placed on a 60° C. hotplate for 2 minutes.

### Polymeric Semiconductor—Spin Coating in Glove Box

The following steps occurred in the glove box that was charged with nitrogen gas. A 0.3 wt % solution of a polymeric semiconductor, (polythiophene, PQT from Xerox) in dichlorobenzene (XSC-2.2, from Xerox) was filtered through a Whatman 1.0 micron GMF filter into a scintillation vial. The wafer with the source-drain silver pattern was placed on spin chuck, completely covered with the polymeric semiconductor solution, and rested for 5 minutes. Spin coating was conducted at 1000 rpm for 90seconds. Once coated the sample was placed on a hotplate at 85° C. and held at 85° C. for 2 hours. Then the hotplate was set to ramp up 5° C./minutes to 140° C. The sample was held at 140° C. for 30 minutes. After the 30minute annealing at 140° C., the hotplate was set to ramp down 5° C./minute to 23° C., allowing for a gradual cool down to room temperature.

### Electrical Measurements

The polymeric semiconductor coated source-drain silver pattern on the wafer was measured for electrical activity using SUS probe station (SUS MicroTec AG, Garching/Hochbrüick, Germany) in the dark since the microscope light and room light affect the electrical measurements. The source-drain having channel length of 20 micron showed linear mobility of 0.0016 cm²/Vsec and on/off ratio of 36.8.

This selective plasma treatment method has an advantage of making conductive source-drain pattern without the need to remove the non-plasma treated silver since the non-treated silver is not conductive. The patterning method requires no lift-off or etching of the silver layer to make source-drain patterns of conductive silver.

What is claimed is:

1. A method for forming a thin layer of particulate on a substrate, comprising:
a) applying a layer of a composition comprising the particulate dispersed in a dispersing agent on the substrate;
b) treating the layer with charged gas to remove the dispersing agent from the layer; and
c) induction heating to form operative connection of the particulate.

2. The method of claim 1 wherein the steps of treating and heating occur at the same time.

3. The method of claim 1 wherein the treating step is with plasma.

4. The method of claim 3 wherein plasma treating is from a gas selected from the group consisting of helium, argon, hydrogen, nitrogen, air, nitrous oxide, ammonia, carbon dioxide, oxygen and combinations thereof.

5. The method of claim 1 wherein the treating step is with ozone in the presence of ultraviolet radiation.

6. The method of claim 1 further comprising cooling the substrate during the induction heating.

7. The method of claim 1 wherein induction heating is with energy selected from the group consisting of microwaves, and radio frequencies.

8. The method of claim 1 wherein the charged gas is plasma and the induction heating is selected from the group consisting of microwave energies and radio frequency energies.

9. The method of claim 1 wherein the layer has a thickness of less than 500 nanometer.

10. The method of claim 1 wherein particulate has particle size between 2 and 500 nanometer.

11. The method of claim 1 wherein the particulate is a metal.

12. The method of claim 1 wherein induction heating step sinters or melts the particulate.

13. The method of claim 1 wherein the particulate is selected from the group consisting of silver, gold, copper, aluminum, titanium, Indium tin oxide, antimony tin oxide, and combinations thereof.

14. The method of claim 1 wherein the dispersing agent is selected from the group consisting of surfactants, binders, and combinations thereof.

15. The method of claim 1 wherein the substrate is a polymeric film.

16. The method of claim 1 wherein the substrate is selected from the group consisting of, plastic, polymeric films, metal, silicon, glass, fabric, paper, and combinations thereof,

17. The method of claim 1 wherein the applying step is selected from the group consisting of injecting, pouring, casting, jetting, immersing, spraying, vapor deposition, spin coating, dip coating, slot coating, roller coating and doctor blade coating.

18. The method of claim 1 wherein the applying step is by printing the composition as a pattern on the substrate.

19. The method of claim 1 wherein the applying step further comprises:
a) providing an elastomeric stamp having a relief structure with a raised surface and a recessed surface;
b) applying the composition to the relief structure; and
c) selectively transferring the composition to the substrate forming a pattern of the composition.

20. The method of claim 19 wherein the transferring of the composition can be from the raised surface or from the recessed surface.

21. The method of claim 19 wherein the stamp has a modulus of elasticity of at least 10 MegaPascal

22. The method of claim 19 further comprising forming the elastomeric stamp from a layer of a photosensitive composition.

23. The method of claim 1 wherein the thin layer of particulate comprises a functional pattern and wherein the applying step is performed by:
a) providing an elastomeric stamp having a relief structure;
b) applying the composition to the relief structure; and
c) selectively transferring the composition from relief structure to the substrate to form the pattern.

24. The method of claim 1 wherein prior to treating step b) the method further comprises:
applying a photoresist material to form a layer disposed above the particulate composition layer;
forming a pattern of the photoresist that creates areas open to the particulate composition layer.

25. The method of claim 24 wherein the step of forming the pattern comprises:
imagewise exposing the photoresist material to actinic radiation; and
developing the photoresist to remove portions and form the pattern.

26. The method of claim 24 wherein the particulate is a metal.

27. The method of claim 1 wherein prior to treating step b), the method further comprises printing a polymeric material that is resistant to the charged gas and is disposed above the particulate composition layer to form a pattern of the polymeric material that creates areas open to the particulate composition layer.

28. The method of claim 27 wherein the printing step is performed with an elastomeric stamp having a relief structure with raised surfaces and recessed surfaces.
